(19) United States
(12) Patent Application Publication
(10) Pub. No.: US 2026/0251003 A1
(43) Pub. Date: Aug. 27, 2026

(54) MODULAR, RECYCLABLE, AND CUSTOMIZABLE SAFE WALLS

(71) Applicant: Cardtronics USA, Inc., Atlanta, GA (US)

(72) Inventors: Mark Alden Lee, Dalgety Bay (GB); Liam Fraser Mccafferty, Dundee (GB); Adam Jack Bela Muir, Edinburgh (GB)

(21) Appl. No.: 19/063,697

(22) Filed: Feb. 26, 2025

(51) Int. Cl. E05G 1/024; G07F 19/00

(52) U.S. Cl. CPC E05G 1/024; G07F 19/205

(57) ABSTRACT

A safe wall includes at least one pre-molded concrete panel with interlocking features designed to engage with adjacent panels. The wall incorporates inner and outer sheet metal plates secured to the concrete panel's surfaces, with reinforcement rods extending through the concrete panel. All fastening mechanisms are accessible only from the interior surface, enabling disassembly while maintaining security. The modular construction allows customization of security levels by selectively modifying reinforcement components without compromising recyclability. The wall construction eliminates traditional welding processes and permanent material bonding, instead utilizing a mechanical assembly approach that enables separation of materials for recycling while meeting CEN EN 1143-1 certification requirements. This design addresses sustainability regulations by allowing complete disassembly of wall components into their respective material classifications at end-of-life, while providing flexibility to upgrade or replace individual elements during service. Furthermore, the wall components can be reused with other safe walls.

### BACKGROUND

Automated Teller Machines (ATMs) contain secure safes that are designed and manufactured to meet stringent security requirements like CEN EN 1143-1 certification. Current ATM safes utilize composite construction methods, such as pouring concrete between inner and outer sheet metal walls with steel reinforcement components embedded within the concrete walls. While this construction provides robust security against various attack methods including thermal, cutting, drilling, hammering and chiseling, it creates significant challenges at the end of the ATM's operational life. The permanent bonding of different materials during manufacturing makes it extremely difficult to separate and recycle the individual components when the ATM is decommissioned. With safes weighing up to 1800 pounds and being purposefully designed to resist disassembly, recycling these units is an expensive and problematic process. This poses a growing challenge as many countries have implemented or are implementing legislation requiring products to be recyclable. The inability to effectively recycle ATM safes has become a barrier for manufacturers in meeting both regulatory requirements and corporate sustainability targets, given that the safe represents a substantial portion of an ATM's volume and cost.

### BRIEF DESCRIPTION OF THE DRAWINGS

FIG. 1A is a diagram of an assembled safe wall, according to an example embodiment.

FIG. 1B is a diagram of various components of a safe wall, according to an example embodiment.

FIG. 1C is a diagram depicting partial components on an interior side of a safe wall, according to an example embodiment.

FIG. 1D is a diagram depicting inserting or removing partial components from an interior side of a safe wall, according to an example embodiment.

FIG. 1E is a diagram depicting the placement of modular concrete panels on an interior side of a safe wall, according to an example embodiment.

FIG. 1F is a diagram depicting securing the modular concrete panels on an interior side of a safe wall, according to an example embodiment.

FIG. 1G is a diagram illustrating how the modular concrete panels are initially placed and partially affixed to an interior surface of an outer wall of a safe wall, according to an example embodiment.

FIG. 1H is a diagram depicting various sizes and thicknesses of the modular concrete panels of a safe wall, according to an example embodiment.

FIG. 1I depicts side cross sectional views of an assembled safe wall, according to an example embodiment.

FIG. 2 is a diagram of a system that utilizes a safe with safe walls, according to an example embodiment.

FIG. 3 is a flow diagram of a method for assembling and disassembling safe walls, according to an example embodiment.

### DETAILED DESCRIPTION

Embodiments presented herein provide modular safe wall construction that enables both security and recyclability. The safe walls utilize pre-molded concrete panels with interlocking features, secured between metal plates using interior-only accessible fastening mechanisms. This construction approach eliminates traditional welding while maintaining CEN EN 1143-1 certification requirements.

The safe walls are configurable to different security grades through modular components including reinforcement rods, concrete panel specifications, and material selections. All assembly and servicing is performed from the interior, maintaining security while enabling future disassembly for recycling.

Current ATM safe construction presents significant manufacturing and sustainability challenges. Traditional safes employ welded sheet metal construction with multiple material layers, requiring complex welding processes that produce toxic fumes during manufacturing. The welded construction, while providing robust security, creates a permanent bonding of materials that makes disassembly extremely difficult. This poses a critical problem as many countries have implemented or are implementing sustainability legislation requiring products to be recyclable. With safes weighing up to 1800 pounds and deliberately designed to resist disassembly, the current recycling process is expensive and problematic. The inability to effectively recycle safe components has become a significant barrier for manufacturers in meeting both regulatory requirements and corporate sustainability targets, particularly since the safe represents a substantial portion of an ATM's volume and cost.

In embodiments presented herein, safe wall construction provides both robust security and environmental sustainability through an innovative modular approach. The safe walls utilize pre-molded concrete panels designed with interlocking features, enabling flexible configuration while maintaining structural integrity. Sheet metal plates and reinforcement rods secure these concrete panels, with all fastening mechanisms accessible only from the interior surface. This construction method enables the safe walls to meet CEN EN 1143-1 certification security requirements while maintaining the ability to be disassembled for recycling.

The safe wall construction presented herein offers flexibility in security configurations through its modular design. The security level of each wall section can be adjusted by modifying component specifications, such as varying the number or thickness of reinforcement rods, adjusting concrete panel thickness, or incorporating additional reinforcement elements. All modifications and assembly processes are conducted from the interior face of the wall, maintaining security integrity by eliminating external access points. This approach enables the production of wall sections that can be configured to order, with the ability to modify security grades based on specific component selections.

The modular wall construction method enables servicing capabilities previously unavailable in traditional safe designs. Individual wall components can be replaced or upgraded as needed, and at the end of the wall section's operational life, all materials can be separated into their respective material classifications for recycling. This feature directly addresses both current and anticipated sustainability requirements while maintaining the robust security standards required for ATM applications.

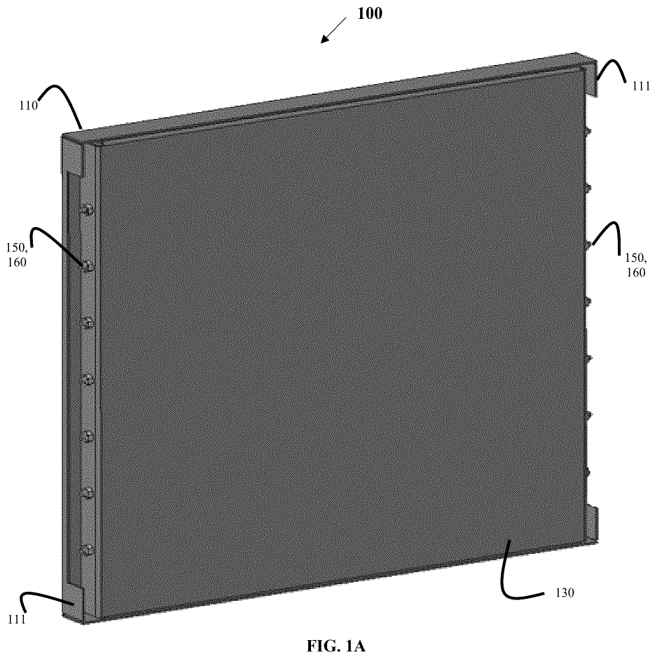

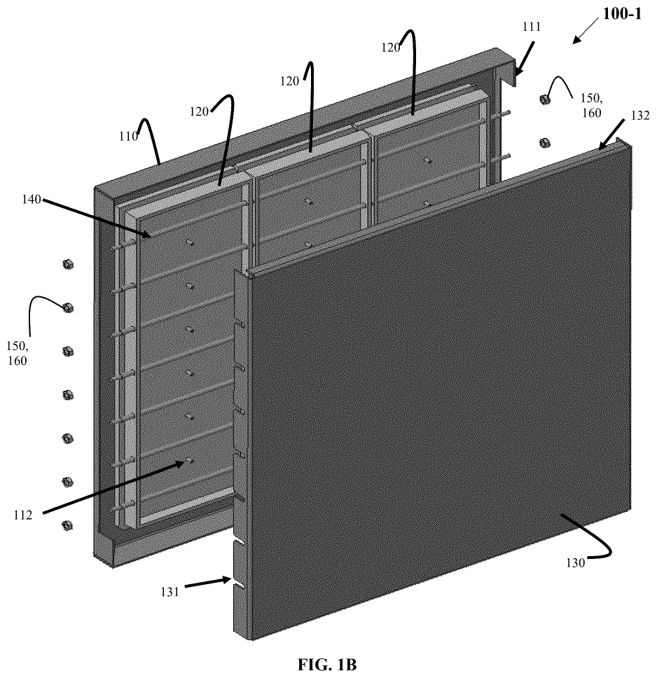

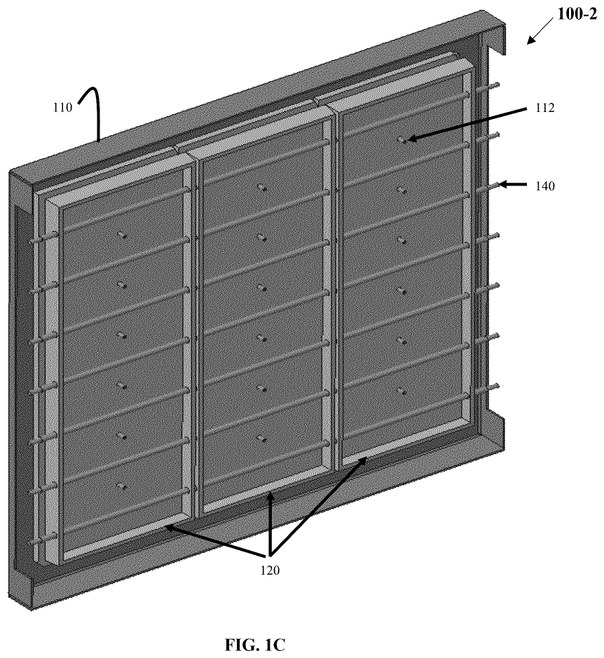

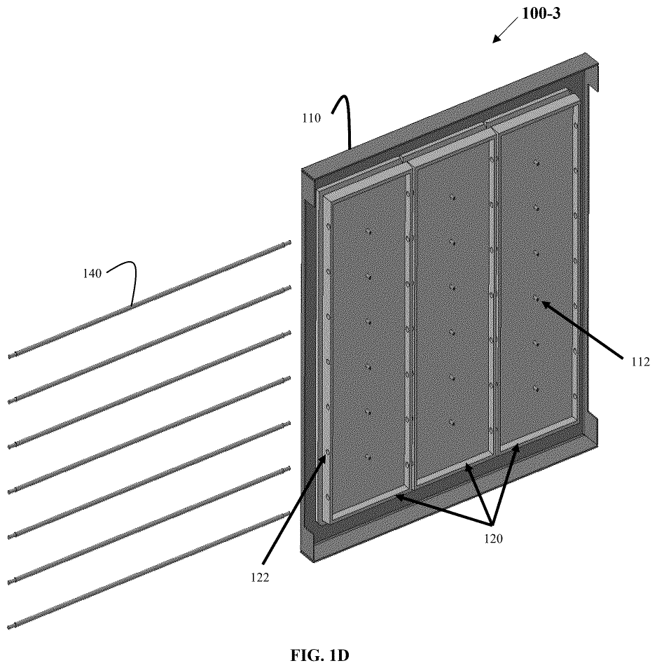

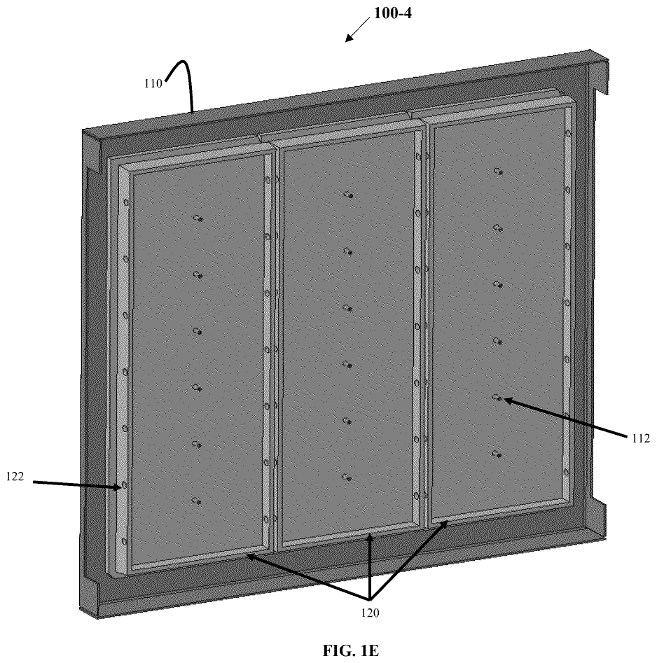

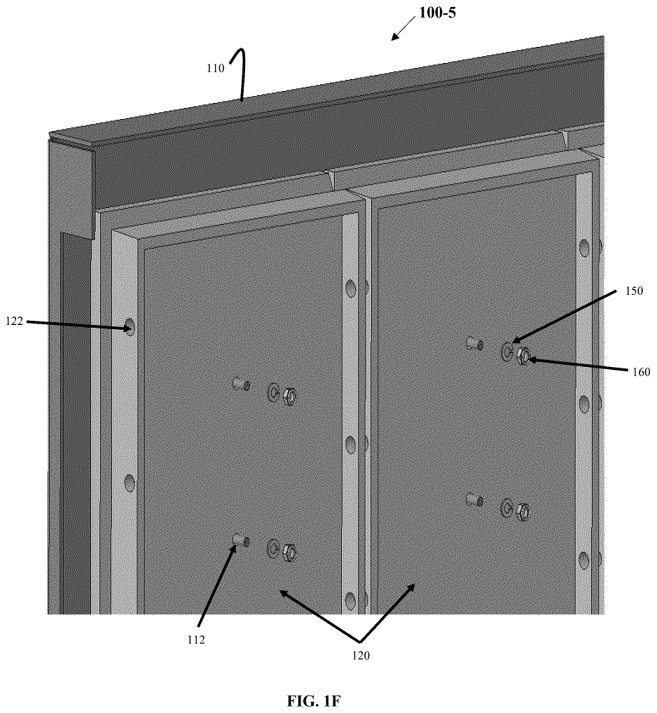

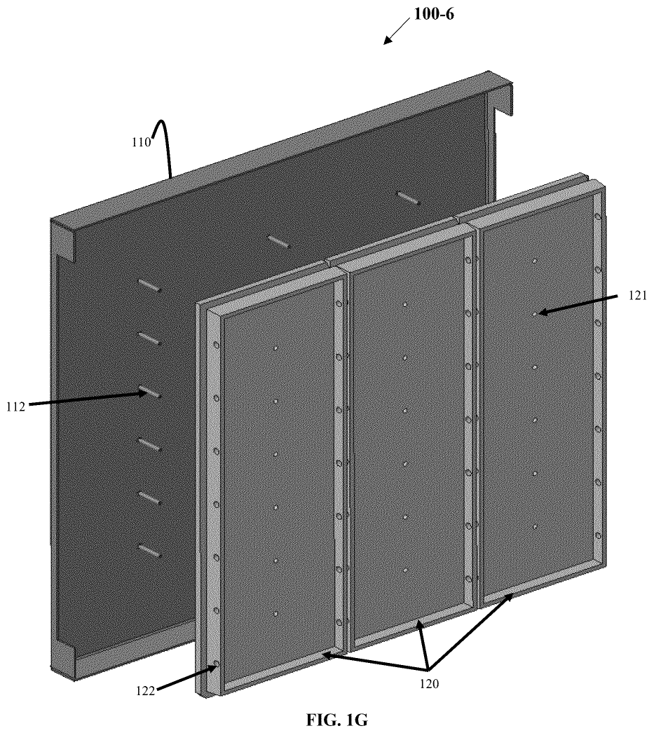

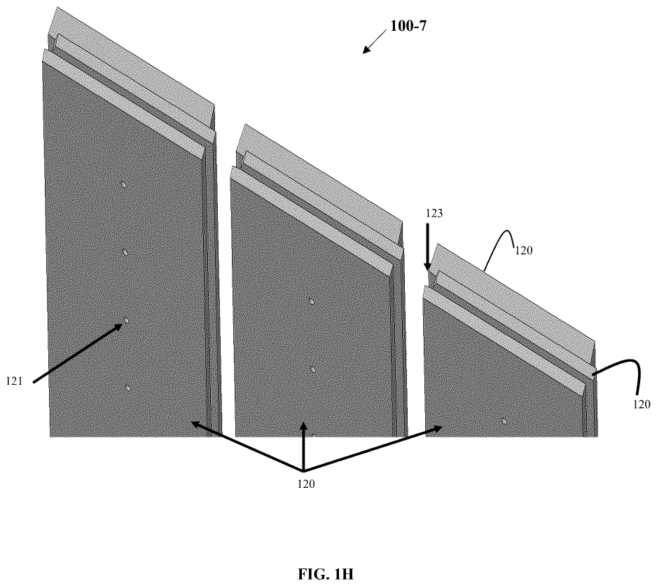

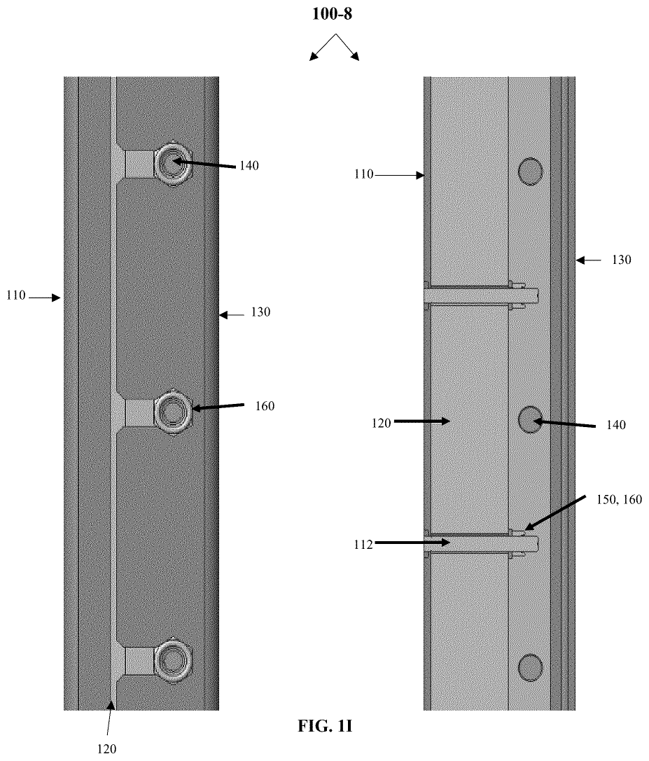

FIG. 1A is a diagram of an assembled safe wall 100, according to an example embodiment. Notably, the components are shown schematically in simplified form, with only those components relevant to understanding of the embodiments being illustrated.

Furthermore, the various components (that are identified in assembled safe wall 100) are illustrated and the arrangement of the components are presented for purposes of illustration only. Notably, other arrangements with more or less components are possible without departing from the teachings of modular, recyclable, and customizable safe walls, presented herein and below.

The fully assembled safe wall 100 illustrated in FIG. 1A visually depicts an outer sheet metal outer-facing wall 110 and a sheet metal interior-facing wall 130. Secured between the outer-facing wall 110 and the interior-facing wall 130 are one or more molded concrete panels 120, shown and discussed below with FIG. 1B. Assembled safe wall 100 also shows visible washers 150 and nuts 160. The washers 150 and nuts 160 are used to secure and affix solid metal rods that run through rod apertures on a side of a first end of the interior-facing wall 130, through apertures manufactured in the sides of the one or more concrete panels 120, and through additional rod apertures on an opposing side end of the interior-facing wall 130 where the washers 150 and nuts 160 securely affix the one or more molded concrete panels to the interior-facing wall 130.

The one or more molded concrete panels 120 are also securely affixed on an interior side of the outer-facing wall 110. The manner in which this is achieved is discussed further below.

Side corners of the outer-facing wall 110 include tabs 111. The interior-facing wall 130 is manufactured to fit snugly under the top and bottom of the outer-facing wall 110 inside the tabs 111. This surrounds and secures one or more molded concrete panels 120 by the outer-facing wall 110 and the interior-facing wall 130 to form a fully assembled safe wall 100.

FIG. 1B is a diagram of various components 100-1 of a safe wall 100, according to an example embodiment. The components are illustrated as partially disassembled.

The outer-facing wall 110 includes a plurality of studs 112 or screws 112 manufactured on an interior side surface of the outer-facing wall 110 and are spaced at regular 100 mm intervals in both the vertical and horizontal directions. In an embodiment the studs 112 are spaced at a configured distance apart based on a desired security setting. The studs 112 extend perpendicular to the interior side surface of the outer-facing wall 110. Moreover, there is no visual indication on the outer side surface of the outer-facing wall 110 as to the location or presence of the studs 112.

The one or more concrete panels 120 include stud apertures through which the studs 112 pass through. Washers 150 and nuts 160 are used to securely affix an outer-facing surface of the one or more concrete panels 120 against the interior side surface of the outer-facing wall 110 at the ends of the studs 112 which are protruding out of an interior surface of the one or more concrete panels 120.

In an embodiment, the one or more concrete panels 120 include a single panel, two panels, or three or more panels. When multiple concrete panels 120 are used the side edges of the concrete panels 120 include tongues on one side of a given panel and a groove on an abutting side of an adjacent panel. The tongue and groove features are precision manufactured to within ±0.1.0 mm tolerances to ensure secure interlocking while maintaining the ability to disassemble. This permits multiple panels to be affixed adjacent to one another using a tongue and groove technique.

The sides of the one or more concrete panels 120 also include rod apertures through which reinforcement steel rods 140 are run through such that each reinforcement steel rod 140 extends slightly beyond a first rod aperture on one side of the one or more concrete panels and extends slightly beyond a last rod aperture on a far and opposing side of the one concrete panels 120. The exposed ends of the rods 140 are secured to the one or more concrete panels 120 via nuts 160 or via washers 150 and nuts 160.

In an embodiment, the thickness and/or number of steel rods 140 used is configurable depending upon the security rating required for the safe wall 100 that is desired. For example, to achieve different CEN EN 1143-1 certification grades, the configuration can be modified by: increasing the diameter of the steel reinforcement rods 140 from standard rebar to thicker chromoly or tungsten steel alloy rods; adding additional parallel reinforcement rods 140 through the rod apertures 122 with standard spacing of 100 mm between rods 140; adjusting the spacing between the reinforcement rods 140 to as close as 50 mm for higher security ratings; or combining multiple configuration changes. In an embodiment, the rods 140 are spaced between a configured distance apart based on a desired security setting. Similarly, the width, thickness, and/or height of the one or more molded concrete panels 120 can be configured based on the desired security rating—for instance, increasing the concrete panel thickness from a standard 40 mm to a greater thickness, incorporating coarse aggregate into the concrete mixture, or using reinforced eco-concrete formulations incorporating recycled material as aggregate for enhanced strength properties. The modular nature of the construction allows these security configurations to be customized during assembly while maintaining the ability to disassemble the wall for recycling or upgrades.

Once the one or more concrete panels 120 are secured to the interior surface of the outer-facing wall 110 and the reinforcement rods 140 are secured to the one or more concrete panels 120, the interior facing wall 130 snugly and securely snaps over the rods 140, via slits 131, under tabs 111, and top and bottom lips 132 under the top and bottom of the outer-facing wall 110. The components of the safe wall 100 including the interior-facing wall 130 are not accessible or visible from the outward surface of the outer-facing wall 110. This provides enhanced security to a safe that utilizes safe walls 100.

FIG. 1C is a diagram depicting partial components 100-2 on an interior side of a safe wall 100, according to an example embodiment. FIG. 1C illustrates a view of the safe wall 100 without the interior-facing wall 130, washers 150, and nuts 160.

Studs 112 are manufactured into and extend outward and perpendicular to an interior surface of the outer-facing wall 110. The one or more concrete panels 120 are aligned such that manufactured apertures permit the studs to extend through the one or more concrete walls 120. Apertures along the sides of the one or more concrete panels 120 permit reinforcement rods 140 to be extended through the one or more concrete panels 120 for added structural reinforcement and security.

FIG. 1D is diagram depicting inserting or removing partial components 100-3 from an interior side of a safe wall 100, according to an example embodiment. FIG. 1D illustrates the manufactured rod apertures 122 through which reinforcement rods 140 are inserted for the length of the one or more molded concrete panels 120.

The rods 140 are easily inserted and removed from an interior of a safe that includes safe walls 100. One or more concrete panels 120 is also easily inserted and removed from the studs 112 via stud apertures manufactured in the front and back surfaces of the one or more concrete panels 120.

The components are removable, reusable, and recyclable. Furthermore, the components are lightweight relative to existing construction of safes and safe walls making it significantly easier to install safe walls 100 and remove safe walls 100 when needed. Thus, the modularity, reusability, customizability, and recyclability of the safe walls 100 provide a significant improvement over existing safe constructions.

FIG. 1E is a diagram depicting the placement 100-4 of modular concrete panels 120 on an interior side of a safe wall 100, according to an example embodiment. FIG. 1E is another diagram illustrating the manufactured rod apertures 122 through which reinforcement rods 140 are inserted for the length of the one or more molded concrete panels 120.

The one or more concrete panels 120 sit on the studs 112 such that there are offset gaps between top and bottom lips of the outer-facing wall 110. The outer-facing surface of the one or more concrete panels, which is adjacent to the interior surface of the outer-facing wall 110, sits substantially flush against the interior surface of the outer-facing wall 110.

FIG. 1F is a diagram depicting securing 100-5 the modular concrete panels 120 on an interior side of a safe wall 100, according to an example embodiment. The offset gap between a top of the one or more concrete panels 120 and a top lip of the outer-facing wall 110 is clearly visible in FIG. 1F. Furthermore, the rod apertures 122 manufactured into the one or more concrete panels 120 is clearly visible in FIG. 1F.

Once the one or more concrete panels 120 are inserted through stud apertures over studs 112, each exposed end of the studs 112 extend past the interior surface of the one or more concrete panels 120. This permits washers 150 to be placed over the exposed ends of the studs 112 followed by nuts 160 tightened over the washers 150 and onto the ends of the studs 112. This ensures that the one or more concrete panels 120 are securely affixed against the outer-facing wall 110 and further ensures that the one or more concrete panels 120 can only be removed with access to an inside of a safe that includes the safe walls 100.

FIG. 1G is a diagram illustrating how the modular concrete panels 120 are initially placed and partially affixed 100-6 to an interior surface of an outer wall 110 of a safe wall 100, according to an example embodiment. FIG. 1G clearly illustrates the manufactured stud apertures 121 through the exterior and interior surfaces of the one or more concrete panels 120.

Additionally, studs 112 manufactured on an interior surface of outer-facing wall 110 are clearly visible in FIG. 1G. The number of studs 112 and corresponding stud apertures 121 are configurable based on the size of a corresponding safe and a desired security rating for the safe.

The stud apertures 121 are aligned with the studs 112 to place the one or more concrete panels 120 on and against the interior surface of the outer-facing wall 110. Again, the one or more concrete panels 120 can be a single panel or more than two panels. In situations where there are more than one panel, each panel can be individually placed over its corresponding studs 112 and a next panel can use a tongue extension along its adjacent side to insert into a grooved portion of an already placed panel to ensure the panels are interlocked together. This approach also makes installation easier. Further, it is noted that for installation the outer-facing wall can be laid on the ground, which will make it easy for a single installer to assemble the safe wall 100.

FIG. 1H is a diagram depicting various sizes and thicknesses 100-7 of the modular concrete panels 120 of a safe wall 100, according to an example embodiment. The height, width, and thickness of the one or more modular concrete panels 120 are configurable based on a desired security rating for the safe that includes safe walls 100. The standard panel thickness starts at 40 mm and can be increased based on security requirements. The panels can be manufactured in various widths and heights to accommodate different safe configurations while maintaining the standardized mounting and interlocking features.

Each panel is molded using reinforced concrete that can be customized with various fillers and compositions to enhance security properties. For example, the concrete panels can utilize eco-concrete formulations that maintain required strength while improving sustainability. The concrete composition can be enhanced with coarse aggregate fillers to increase structural integrity and attack resistance. Additional reinforcement options include incorporating steel fibers, specialized hardening agents, or other strengthening additives into the concrete mixture during the molding process. Moreover, sides of some panels can be manufactured with tongues 123 and grooves along one side to interlock multiple panels together. The modular nature allows panels to be manufactured with different concrete compositions and filler combinations while maintaining compatibility through standardized dimensions and interlocking features.

The concrete panels can be manufactured using eco-concrete formulations that provide environmental benefits while maintaining required security properties. For example, the concrete mixture can incorporate recycled materials as aggregate, use lower-carbon cement alternatives, or employ specialized additives that reduce the overall environmental impact of the panels. The eco-concrete options can be customized based on local availability of sustainable materials while ensuring the finished panels meet CEN EN 1143-1 certification requirements. This approach aligns with the overall sustainability goals of the safe wall design by utilizing environmentally conscious materials that can still be effectively recycled at end-of-life. The eco-concrete formulations can be used in conjunction with the reinforcement rods and other security features to achieve different certification grades while maintaining improved environmental characteristics.

The pre-molded concrete panels 120 are manufactured using precision molds that ensure consistent dimensions within ±2 mm tolerances. Quality control measures during panel production include verification of aperture alignment, testing of tongue and groove interlocking features, and confirmation of concrete strength specifications. This ensures consistent dimensions with configured tolerances and verification of aperture alignment during production. The manufacturing process can be performed at local facilities, reducing transportation costs and environmental impact while maintaining strict quality standards.

FIG. 1I depicts side cross sectional views 100-8 of an assembled safe wall 100, according to an example embodiment. The figure to the left illustrates nuts 160 connected inside an assembled safe wall 100 affixed and secured to rods 140. The overall wall thickness from outer surface to inner surface measures approximately 40 mm in the standard configuration, with the space between the outer-facing wall 110 and interior-facing wall 130 being sufficient to accommodate the concrete panels 120. In an embodiment, the outer-facing wall 110 and the interior-facing wall 130 are constructed of high-strength steel with a minimum configured thickness. The outer-facing wall 110 and the interior-facing wall 130 snap snugly and securely around the one or more concrete panels 120 providing a secure safe wall 100 that can only be disassembled from an interior of a safe that includes safe walls 100. In an embodiment, the nuts 160 are M10 self-locking nuts.

The figure to the right illustrates studs 112 emanating from the interior surface of the outer-facing wall 110 and secured by washer 150 and nuts 160 on an interior side of interior-facing wall 130. Again, the one or more concrete panels 120 are snugly and securely sandwiched between the outer-facing wall 110 and the interior-facing wall 130. Further, reinforcement rods 140 extend through the sides of the one or more concrete panels 120.

In an embodiment, the studs 112 are M6 studs. In an embodiment, the reinforcement rods 140 are steel and/or rebar. The diameter of each rod 140 and number of rods 140 used in the safe wall 100 is configurable.

The safe wall components utilize specific material grades to achieve security certification requirements. The outer-facing wall 110 and interior-facing wall 130 are constructed from high-strength steel, such as chromoly or tungsten steel alloys, with a minimum thickness of 2 mm. The reinforcement rods 140 can be manufactured from standard rebar for basic configurations or upgraded to higher-grade steel alloys such as chromoly for enhanced security ratings. The studs 112 are precision-manufactured from hardened steel, with M6 grade specifications ensuring consistent thread engagement with the corresponding nuts 160. The pre-molded concrete panels 120 are engineered to achieve minimum compressive strength ratings appropriate for CEN EN 1143-1 certification, typically ranging from 40-60 MPa depending on the security grade required. Manufacturing tolerances for all metal components are maintained within ±0.5 mm to ensure proper alignment and secure assembly, while concrete panel dimensions are controlled within ±2 mm to maintain consistent fit and security performance.

The safe walls 100 can be adjoined to one another using several secure connection approaches. In one embodiment, adjacent concrete panels 120 include curved interior corners with a 90-degree radius and prefabricated apertures spaced at 50 mm intervals to align when panels are positioned at right angles. These aligned apertures accommodate heavy-duty steel bolts that secure adjacent walls together from the interior of the safe. The interior-facing walls 130 are specially manufactured with modified edges to accommodate these curved concrete panel corners while maintaining their ability to snap securely into the corresponding outer-facing walls 110. For enhanced security, the adjacent corners of both the outer-facing wall 110 and interior-facing wall 130 include interlocking features that can be bolted together from the interior. Alternative embodiments may utilize different corner joining mechanisms, such as reinforced corner pieces that integrate with the modular panels, or specialized connector brackets that secure to the reinforcement rods 140 of adjacent walls, while maintaining the ability to disassemble the structure from the interior for servicing or recycling. All corner joining mechanisms are designed to achieve the required security certification levels while preserving the modular and recyclable nature of the safe wall construction.

In an embodiment, alternative fasteners or fixings can be used to secure the rods 140, the studs 112 and two adjacent safe walls 100. For example, fastening mechanisms can include, by way of example only, locking pins, snap rings, retaining clips or spring clips, Nylon-insert lock nut, jam nut, castle nuts and cotter pins, keyed or splined connections, and others.

Regular inspection and maintenance of the safe walls 100 can be performed without compromising security or recyclability. The modular design allows for individual component replacement if damage occurs. Inspection points include verification of proper rod tension, examination of panel interlocking connections, and assessment of fastener integrity. All maintenance can be performed from the interior while maintaining the security rating of the safe wall.

The modular safe wall construction presented herein eliminates traditional welding processes that produce toxic fumes during manufacturing. By using mechanical assembly methods instead of welded construction, the safe walls 100 avoid the environmental hazards associated with welding fumes while maintaining required security levels. This approach not only improves worker safety during manufacturing but also aligns with environmental sustainability goals by eliminating harmful emissions. The elimination of welding processes further enables more flexible manufacturing options, including local production capabilities that can reduce transportation environmental impact.

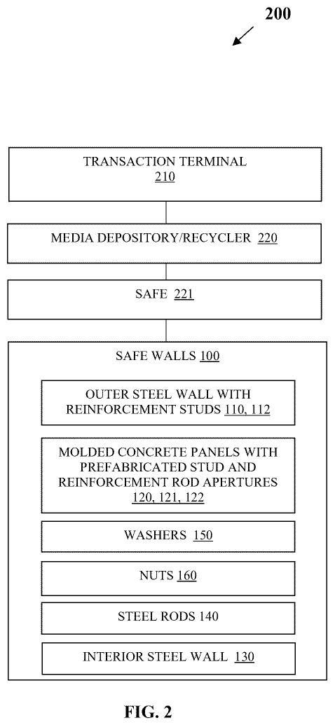

FIG. 2 is a diagram of a system 200 that utilizes a safe with safe walls, according to an example embodiment. Notably, the components are shown schematically in simplified form, with only those components relevant to understanding of the embodiments being illustrated.

Furthermore, the various components (that are identified in system 200) are illustrated and the arrangement of the components are presented for purposes of illustration only. Notably, other arrangements with more or less components are possible without departing from the teachings of modular, recyclable, and customizable safe walls, presented herein and below.

System 200 includes a transaction terminal 210 and a media depository/recycler 220. Depository/Recycler 220 further includes a media safe 221. Safe 221 includes safe walls 100. Each wall 100 includes an outer steel wall 110 with reinforcement studs 112 as illustrated in FIG. 1G. Each wall 100 further includes the one or more molded concrete panels 120 with prefabricated stud apertures 121 and steel reinforcement rod apertures 122. Each wall 100 further includes washers 150 and nuts 160 to securely affix the molded concrete panels 120 to an interior surface of the outer steel wall 110 via studs 112, washers 150, and nuts 160. The one or more molded concrete panels are reinforced via steel rods 140 and nuts 160.

Transaction terminal 210 includes at least one processor and a non-transitory computer-readable medium, which includes instructions for a transaction manager. The instructions when executed by the processor cause the processor to perform operations relevant to media-based transactions by interacting with the media depository/recycler 220 to deposit and dispense media for a given transaction. In an embodiment, the transaction terminal 210 is an automated teller machine (ATM). In an embodiment, the transaction terminal 210 is a self-service terminal.

Media depository/recycler 220 includes at least one processor and a non-transitory computer-readable storage medium, which includes instructions for a media controller. The instructions when executed by the processor cause the processor to perform media deposits and withdrawals from the safe 221.

The safe 221 and corresponding safe walls 100 are entirely serviced and disassembled for recycling or reuse only from an interior of the safe 221. The safe 221 maintains security integrity by eliminating access points to the safe walls 100. The safe walls 100 enable individual component replacement if damage occurs with inspection points including verification of proper rod tension, examination of panel interlocking connections, and assessment of fastener integrity only from the inside of the safe 221.

The media depository/recycler 220 is interfaced to the transaction terminal 210 as a peripheral device of the transaction terminal 210. The media depository/recycler 220 controls movement of media into and out of the safe 221 during media transaction at the transaction terminal 210.

The system description above outlines how the modular safe walls 100 integrate with transaction terminals 210 and media handling equipment. While the safe walls 100 provide secure storage for such systems, their innovative construction approach enables benefits beyond just security. The modular design and interior-only access features that protect media during transactions also facilitate assembly, maintenance, and eventual recycling of the safe walls themselves.

Having described various embodiments of the modular, recyclable, and customizable safe walls 100 above, attention is now directed to methods for assembling and disassembling such safe walls 100. The methods described below demonstrate how the modular construction approach enables both secure assembly and environmentally conscious disassembly. By following these methods, service personnel can construct safe walls that meet certification requirements while preserving the ability to separate and recycle components at end-of-life. The assembly and disassembly procedures leverage the innovative mechanical connections and interior-only access design to maintain security throughout the safe wall lifecycle.

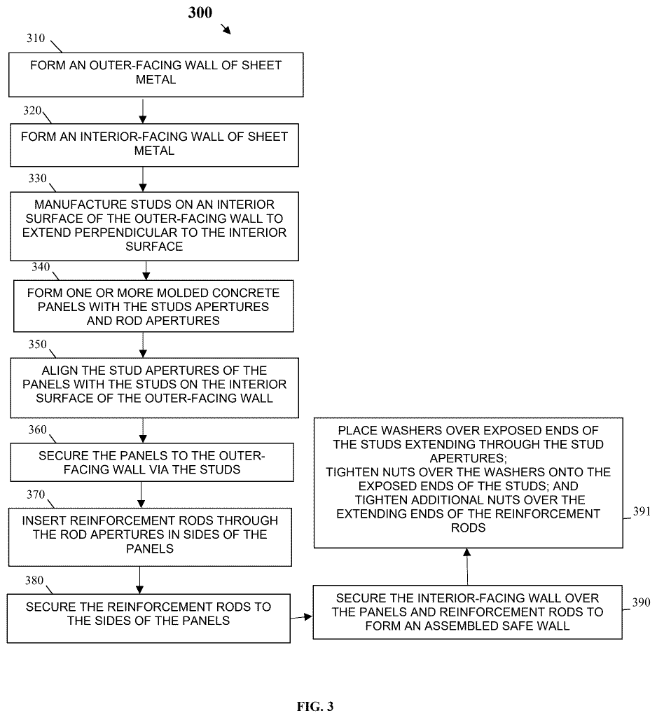

FIG. 3 is a flow diagram of a method 300 for assembling and disassembling safe walls, according to an example embodiment. At 310, an outer-facing wall 110 for a safe wall 100 is formed from sheet metal. At 320, an interior-facing wall 130 of the safe wall is formed from sheet metal.

At 330, studs 112 are manufactured on an interior surface of the outer-facing wall 110 to extend perpendicular to the interior surface of the outer-facing wall. At 340, one or more molded concrete panels 120 are formed with stud apertures 121 and rod apertures 122.

At 350, the stud apertures 121 or the panels 120 are aligned with the studs 112 on the interior surface of the outer-facing wall 110. At 360, the panels 120 are secured to the interior surface of the outer-facing wall 110 via the studs 112.

At 370, reinforcement rods 140 are inserted through the rod apertures 122 in sides of the panels 120. At 380, the reinforcement rods 140 are secured to the sides of the panels 110.

At 390, the interior-facing wall 130 is secured over the panels 120 and reinforcement rods 140 and secured to the outer-facing wall 110 to form an assembled safe wall 100. In an embodiment, at 391, washers 150 are placed over exposed ends of the studs 112 extending through the stud apertures 121. Nuts 160 are tightened over the washers 150 onto the exposed ends of the studs 112. Additional nuts 160 are tightened over extending ends of the reinforcement rods 140.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method comprising:
an outer-facing wall formed of sheet metal;
an interior-facing wall formed of sheet metal;
one or more molded concrete panels secured between the outer-facing wall and the interior-facing wall via studs manufactured on an interior surface of the outer-facing wall, wherein the studs extend perpendicular to the interior surface; and
reinforcement rods extending through rod apertures in sides of the one or more molded concrete panels and secured to the sides.

2. The method of claim 1, wherein the outer-facing wall includes tabs at side corners, and wherein the interior-facing wall fits snugly under top and bottom portions of the outer-facing wall inside the tabs.

3. The method of claim 1, wherein the one or more molded concrete panels include tongue and groove features precision manufactured to within configured tolerances to ensure secure interlocking between adjacent molded concrete panels.

4. The method of claim 1, wherein the studs are spaced at regular configured intervals in both vertical and horizontal directions.

5. The method of claim 1, wherein the reinforcement rods are spaced between a configured distance apart based on a desired security rating.

6. The method of claim 1, wherein the one or more molded concrete panels has a configured thickness.

7. The method of claim 1, wherein the outer-facing wall and interior-facing wall are constructed from high-strength steel with a minimum configured thickness.

8. The method of claim 1, wherein the one or more molded concrete panels are manufactured using eco-concrete formulations incorporating recycled materials as aggregate.

9. The method of claim 1, further comprising washers and nuts that secure the studs and the reinforcement rods.

10. The method of claim 9, wherein washers and nuts securing the studs and the reinforcement rods are only accessible from an interior side of the outer-facing wall.

11. The method of claim 1, wherein the one or more molded concrete panels are manufactured using precision molds that ensure consistent dimensions within configured tolerances and include verification of aperture alignment during production.

12. A system, comprising:
a transaction terminal;
a media depository/recycler interfaced to the transaction terminal; and
a safe including safe walls, wherein each safe wall comprises:
an outer-facing wall formed of sheet metal;
an interior-facing wall formed of sheet metal;
one or more molded concrete panels secured to an interior surface of the outer-facing wall via studs manufactured on the interior surface of the outer-facing wall, wherein the studs extend perpendicular to the interior surface; and
reinforcement rods extending through rod apertures in sides of the one or more molded concrete panels and secured to the sides;
wherein the transaction terminal is configured to perform media transactions using the media depository/recycler;
wherein the media depository/recycler is configured to control movement of media during the media transactions into and out of the safe.

13. The system of claim 12, wherein the transaction terminal is an automated teller machine or a self-service terminal.

14. The system of claim 12, wherein the safe walls are configured to meet CEN EN 1143-1 certification security requirements while maintaining ability to be disassembled for recycling.

15. The system of claim 12, wherein the safe walls can only be disassembled from inside the safe.

16. The system of claim 12, wherein the safe walls are configurable to different security grades through modular component specifications including reinforcement rod thickness, concrete panel thickness, and material selections.

17. The system of claim 12, wherein the safe walls are assembled and serviced entirely from an interior of the safe while maintaining security integrity by eliminating external access points.

18. The system of claim 12, wherein the safe walls enable individual component replacement if damage occurs, with inspection points including verification of proper rod tension, examination of panel interlocking connections, and assessment of fastener integrity.

19. A method, comprising:
forming an outer-facing wall of sheet metal;
forming an interior-facing wall of sheet metal;
manufacturing studs on an interior surface of the outer-facing wall to extend perpendicular to the interior surface;
forming one or more molded concrete panels with stud apertures and rod apertures;
aligning the stud apertures of the one or more molded concrete panels with the studs on the interior surface of the outer-facing wall;
securing the one or more molded concrete panels to the outer-facing wall via the studs;
inserting reinforcement rods through the rod apertures in sides of the one or more molded concrete panels;
securing the reinforcement rods to the sides of the one or more molded concrete panels; and
securing the interior-facing wall over the one or more molded concrete panels and reinforcement rods to form an assembled safe wall.

20. The method of claim 19, wherein securing the one or more molded concrete panels and the reinforcement rods comprises:
placing washers over exposed ends of the studs extending through the stud apertures;
tightening nuts over the washers onto the exposed ends of the studs; and
tightening additional nuts over extending ends of the reinforcement rods.
